(19) United States
(12) Patent Application Publication
(10) Pub. No.: US 2026/0208583 A1
(43) Pub. Date: Jul. 23, 2026

(54) HUD AND CLUSTER INTEGRATED DISPLAY ASSEMBLY

(71) Applicants: HYUNDAI MOTOR COMPANY, SEOUL (KR); KIA CORPORATION, SEOUL (KR)

(72) Inventor: Won-Suk Lim, Hwaseong-si (KR)

(73) Assignees: HYUNDAI MOTOR COMPANY, SEOUL (KR); KIA CORPORATION, SEOUL (KR)

(21) Appl. No.: 19/251,152

(22) Filed: Jun. 26, 2025

(30) Foreign Application Priority Data
Dec. 13, 2024 (KR) 10-2024-0185937

(51) Int. Cl. B60K 35/231; B60K 35/235; G02B 27/01

(52) U.S. Cl. CPC B60K 35/231; B60K 35/235; G02B 27/0101; G02B 2027/0141

(57) ABSTRACT

A heads-up display (HUD) and cluster integrated display assembly for a vehicle includes a display module rotatably installed on a crash pad of a vehicle. A portion of the display module displays HUD information formed as an image on a windshield, and the remaining portion of the display module displays cluster information.

### CROSS REFERENCE TO RELATED APPLICATIONS

This application claims priority to Korean Patent Application No. 10-2024-0185937, filed on Dec. 13, 2024, which is incorporated herein by reference in its entirety.

### BACKGROUND

### Field of the Disclosure

The present disclosure relates to a heads-up display (HUD) and cluster integrated display assembly, which uses a single display module to display HUD and cluster information.

### Description of Related Art

A cluster is mounted in a vehicle, allowing a driver to display the vehicle's driving information, such as the vehicle's speed, the engine's revolutions per minute (RPM), and fuel efficiency, or status information, such as fuel level and coolant temperature.

In addition, through an HUD configured to form a portion of navigation information as an image on the windshield mounted on the vehicle, the driver may easily receive route guidance without needing to referring to the Audio, Video, and Navigation (AVN).

The cluster is mounted on a crash pad, allowing the driver to look at the cluster through a steering wheel. The cluster may be provided as a display with a variety of themes.

The HUD, which is a display mounted on an upper surface of the crash pad, forms the information on the display as an image on the windshield. Accordingly, the driver may easily receive route guidance without shifting their gaze to the AVN.

The cluster and the HUD can be mounted as separate displays, thereby increasing the space required for respective mountings. In order for the driver to easily look at the cluster and the HUD during driving, both the cluster and the HUD should be disposed in front of the driver's seat in a lengthwise direction of the vehicle. Accordingly, to prevent the cluster and the HUD from overlapping, the cluster and the HUD should be disposed to be spaced apart from each other, thereby inevitably requiring more space for mounting the cluster and the HUD.

In particular, as the so-called engine room has recently been miniaturized due to the electrification of vehicles, the crash pad has also been miniaturized, thereby further limiting the mounting space for the cluster and the HUD.

In addition, as display modules that constitute the HUD and the cluster, respectively, should be provided separately, the number of display modules required increases, thereby increasing production cost.

### SUMMARY

Various aspects of the present disclosure are to provide a heads-up display (HUD) and cluster integrated display assembly, which uses a single display module to display both cluster information and HUD information.

An HUD and cluster integrated display assembly according to the present disclosure may include a display module disposed on a crash pad of a vehicle, wherein a portion of the display module displays HUD information formed as an image on a windshield, and a remaining portion of the display module displays cluster information.

The display module may be rotatably installed on the crash pad and divided into an HUD area configured to display the HUD information and a cluster area configured to display the cluster information.

In the display module, the HUD area may be located at an upper portion the display module, and the cluster area is located below the HUD area.

As the display module rotates, a ratio between the HUD area and the cluster area in the display module may change.

The display module may include a convexly curved display.

The HUD and cluster integrated display assembly may further include a drive motor mounted on the crash pad, and a support configured to support a bottom surface of the display module and rotate by the drive motor.

The HUD and cluster integrated display assembly may further include a control unit configured to transmit information to be displayed to the display module and control the operation of a drive motor configured to rotate the display module.

A dividing line, configured to partition the HUD area and the cluster area, is formed in the display module.

The control unit may be configured to determine a location of a dividing line in the display module, such that the dividing line is located above a lower end of a reflectable area in the windshield, and HUD information is formed as an image on the windshield.

The control unit may be configured to correct an image displayed on the display module such that the image displayed from the display module appears flat.

When the display module rotates, the control unit may move the dividing line in a direction opposite to a rotation direction of the display module.

The HUD and cluster integrated display assembly may further include an image generation unit configured to generate images to be displayed on the HUD area and the cluster area in the display module and provide the generated images to the control unit.

The control unit may be configured to detect a driver's eye position by using an interior camera mounted within the vehicle and correct images to be displayed on the HUD area and the cluster area.

A head-up display (HUD) and cluster integrated display assembly for a vehicle, may comprise a crash pad of a vehicle, a display module rotatably installed on the crash pad of the vehicle, and a control unit configured to transmit information to be displayed to the display module and control a rotation the display module. A portion of the display module displays HUD information formed as an image on a windshield, and a remaining portion of the display module displays cluster information.

The display module may include an HUD area configured to display the HUD information, a cluster area configured to display the cluster information, and a dividing line configured to partition the HUD area and the cluster area.

An image generation unit may be further provided to generate images to be displayed on the HUD area and the cluster area in the display module.

A camera may be installed in an interior of the vehicle to detect an eye position of a driver of the vehicle, and wherein the control unit is configured to detect a driver's eye position by using the camera and correct images to be displayed on the HUD area and the cluster area.

The control unit is configured to correct an image displayed on the display module such that the image displayed from the display module appears flat and determine a location of the dividing line in the display module.

The display module rotates by the control unit to move the dividing line.

The display module includes a convexly curved display curved in an upward direction from the crash pad of the vehicle.

With the HUD and cluster integrated display assembly of the present disclosure having the configuration described above, by displaying a cluster image and an HUD image through a single display module, a cluster and an HUD may be implemented in a small space.

In addition, by using a curved display and adjusting an installation angle thereof, a user may adjust locations of the cluster image and the HUD image and a ratio therebetween as desired by the user or based on the user's eye position.

Furthermore, since the cluster and the HUD may be implemented with a single display module, the number of display modules required may be decreased, thereby reducing the vehicle's production costs.

### BRIEF DESCRIPTION OF THE FIGURES

FIG. 1 is a schematic view illustrating an HUD and cluster integrated display assembly according to an embodiment of the present disclosure.

FIG. 2 is a schematic view illustrating a display module and a configuration for adjusting an angle of the display module in the HUD and cluster integrated display assembly according to an embodiment of the present disclosure.

FIG. 3 is a schematic view illustrating an example where a cluster image and an HUD image are displayed, respectively, in a display area in the HUD and cluster integrated display assembly according to an embodiment of the present disclosure.

FIG. 4 is a schematic view illustrating a state in which an angle of the display module is adjusted in the HUD and cluster integrated display assembly according to an embodiment of the present disclosure.

### DETAILED DESCRIPTION

Hereinafter, an HUD and cluster integrated display assembly according to an embodiment of the present disclosure will be described in detail with reference to the accompanying drawings.

An HUD and cluster integrated display assembly according to an embodiment of the present disclosure may include a display module 21 rotatably installed on a crash pad 12 of a vehicle, wherein a portion of the display module 21 displays HUD information formed as an image on a windshield 11, and a remaining portion of the display module 21 displays cluster information.

The display module 21 may be disposed in front of a driver's seat in a vehicle. That is, the display module 21 may be rotatably installed on the crash pad 12.

A portion of the display module 21 may display HUD information formed as an image on the windshield 11, and the remaining portion of the display module 21 may display cluster information.

An HUD typically may display key information of navigation information displayed through the vehicle's Audio, Video, and Navigation (AVN). The key information may be displayed on a portion of the display module 21.

In addition, the vehicle's cluster may display cluster information, such as the vehicle's driving information and status information. The cluster information may be displayed on the remaining area of the display module 21.

For example, the display module 21 may be divided into an HUD area 21a on which the HUD information is displayed and a cluster area 21b on which the cluster information is displayed.

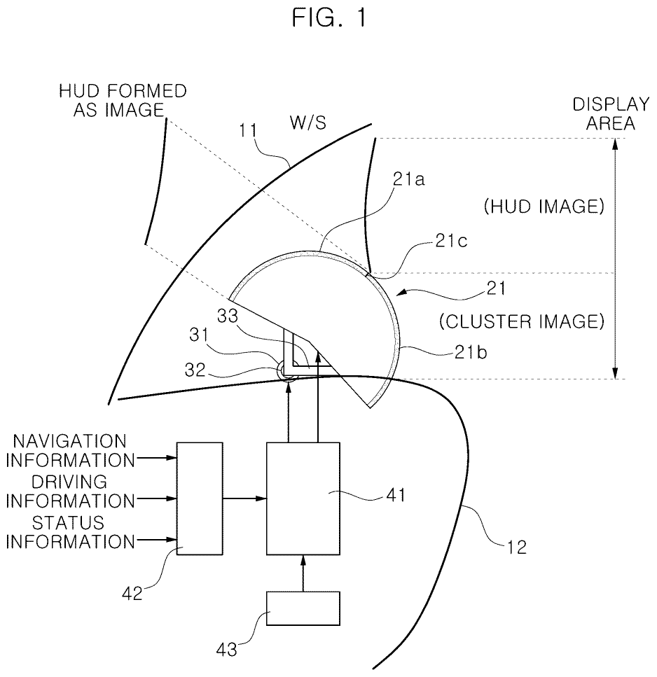

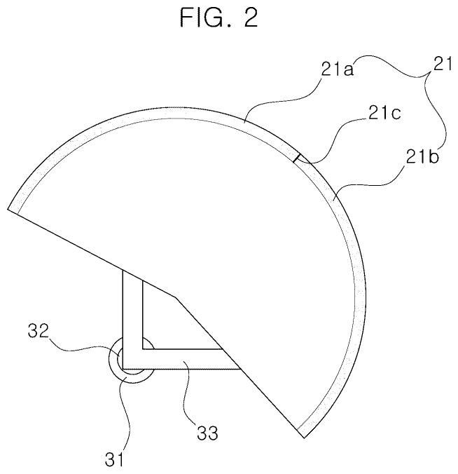

As illustrated in FIGS. 1 and 2, the display module 21 may be formed to be convex, for example, in an upward direction from the crash pad 12 of the vehicle, when viewed from a side. To this end, the display module 21 may be provided with a curved display. Since the display module 21 is provided with the curved display, which is convex toward the upward direction from the crash pad 12 of the vehicle, the HUD information may be projected onto the windshield 11 of the vehicle, while at the same time the cluster information may be displayed inside the vehicle.

Images displayed through the HUD area 21a and the cluster area 21b may be perceived by a driver as flat. That is, as illustrated on the right side of FIG. 1, an upper portion of the image displayed through the display module 21 may become an HUD image, and a lower portion thereof may become a cluster image.

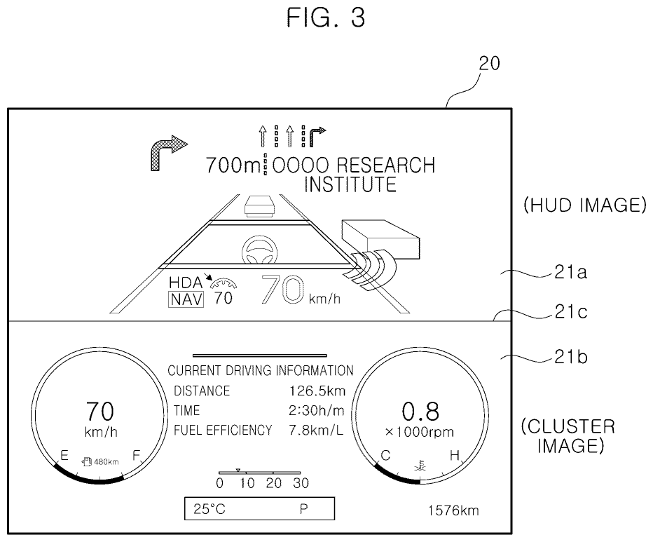

When unfolded, the display module 21 may appear as illustrated in FIG. 3. The display module 21 may include a curved display, but when the display module 21 is unfolded, an upper portion of the display module 21 may become the HUD area 21a, on which the HUD information is displayed, and a lower portion thereof may become the cluster area 21b, on which the cluster information is displayed.

In the display module 21, the HUD area 21a may be located at an upper portion of the display module 21 and the cluster area 21b may be located below the HUD area 21a. An HUD may typically appear above the vehicle's cluster, and thus in the display module 21 as well, the HUD area 21a may be located above the cluster area 21b.

In the display module 21, a dividing line 21c may be formed between the HUD area 21a and the cluster area 21b to divide the two areas.

However, in the display module 21, the HUD area 21a, the cluster area 21b, and the dividing line 21c may not be formed in a predetermined size. Rather, the HUD area 21a and the cluster area 21b may be partitioned within a single display, and the dividing line 21c may be formed therebetween.

A location of the dividing line 21c in the display module 21 may be determined such that the dividing line 21c is located above a lower end of a reflectable area in the windshield 11. The reflectable area, which the HUD information is reflected onto and formed as an image on, may be created depending on the design of the windshield 11. The location of the dividing line 21c in the display module 21 is determined such that the dividing line 21c is formed as an image on the windshield 11 above the lower end of the reflectable area.

By rotating the display module 21, a ratio between the HUD area 21a and the cluster area 21b may be adjusted. That is, in the display module 21, the size of the display may be fixed, but the size of any one of the HUD areas 21a and the cluster area 21b may be increased, and the size of the other thereof may be decreased.

The display module 21 may be rotatably installed such that the locations of the HUD area 21a and the cluster area 21b may be adjusted based on the driver's gaze. As the display module 21 rotates around a width direction of the vehicle as an axis, the ratio between the HUD area 21a and the cluster area 21b within the display module 21 may be adjusted.

In order to rotate the display module 21, as illustrated in FIG. 2, a drive motor 31 and a support 33, which supports the display module 21 and rotates by the drive motor 31, may be provided.

The drive motor 31 may be mounted on the crash pad 12 and, when power is applied, rotate to cause the display module 21 to rotate.

The support 33 may support a bottom surface of the display module 21 and have one end secured to a rotation shaft 32 of the drive motor 31.

The drive motor 31 may be installed on the crash pad 12, and a portion of the display module 21 may be installed to be accommodated in the crash pad 12.

Accordingly, rotation of the drive motor 31may cause the support 33 to rotate, such that the display module 21 rotates. That is, when the drive motor 31 rotates, the display module 21 may rotate clockwise or counterclockwise as shown in FIGS. 1 and 2, depending on a rotation direction of the drive motor 31.

A control unit 41 may transmit information to be displayed to the display module 21 and control an operation of the drive motor 31 that rotates the display module 21.

The control unit 41 may rotate the display module 21 in response to information input from an external source. In addition, when information to be displayed on the display module 21 is input to the control unit 41, the control unit 41 may transmit the information to the display module 21 such that the information is displayed on the display module 21.

In addition, the control unit 41 may correct an image finally provided to the display module 21. For example, the image may be corrected such that the driver may perceive the image displayed on the display module 21, which is formed with a curved surface, as flat. To this end, the control unit 41 corrects a warping, i.e., a distortion of the image formed on the windshield 11 according to a curvature being matched that of the windshield 11.

An image generation unit 42 may generate images to be displayed on the HUD area 21a and the cluster area 21b in the display module 21, and provide the generated images to the control unit 41.

The image generation unit 42 may generate an image to be displayed on the display module 21 by using navigation information provided by the AVN of the vehicle, the vehicle's driving information and status information provided by the control unit 41 of the vehicle, or the like.

The image generation unit 42 may receive navigation information or a portion thereof from the vehicle's AVN or the like, and generate an image to be displayed on the HUD area 21a. For example, information such as the vehicle's speed, direction of travel, and remaining distance may be generated. In addition, information regarding a driving assistance device provided by the control unit 41 of the vehicle, such as lane-keeping information and a degree of approach of a nearby vehicle, may also be generated.

In addition, the image generation unit 42 may generate an image of the vehicle's driving information and status information provided by the control unit 41 of the vehicle. That is, the image generation unit 42 may generate an image of the information that is conventionally displayed through a vehicle's cluster. For example, the driving information may be information related to the driving of the vehicle, such as the vehicle's speed, revolutions per minute (RPM), and fuel efficiency. The status information may be information related to the vehicle's status, such as fuel level and coolant temperature. In addition, if the vehicle is a hybrid or electric vehicle, the image generation unit 42 may generate an image to include information relevant thereto.

The image generated by the image generation unit 42 may be transmitted to the control unit 41, and the control unit 41 may transmit the image to the display module 21, such that the image is displayed on the display module 21.

An interior camera 43 may be installed in an interior of the vehicle to detect an eye position of the driver of the vehicle. The interior camera 43 may be a camera, which is installed in the interior of the vehicle such as a rearview mirror and identify the driver's head position, eye position, gaze direction, and eye blinking. The interior camera 43 may be used to monitor the driver's drowsiness and inattentiveness. In the present disclosure, the driver's eye position may be detected using the interior camera 43. Accordingly, based on the driver's eye position, a location of the image formed as an image on the windshield 11 may be corrected, or the image displayed on the cluster area 21b may be corrected.

In addition, the information on the driver's eye position detected by the interior camera 43 may be transmitted to the control unit 41. The control unit 41 may use the transmitted information from the interior camera 43 to adjust a location of the image formed as an image on the windshield 11, and further corrects a distortion of the image, e.g., a warping, formed on the windshield 11 according to the curvature of the windshield 11, such that the image formed on the windshield 11 may be perceived as flat by the driver.

In the HUD and cluster integrated display assembly according to the present disclosure having the configuration described above, as illustrated in FIG. 1, a portion of the image displayed on the display module 21 may be reflected onto the windshield 11, such that an HUD image is formed as an image on the windshield 11 and perceived by the driver. Since the HUD image is formed as an image on the windshield 11 and perceived by the driver, the HUD image may be displayed in an inverted state on the HUD area 21a. In addition, the remaining portion of the image displayed on the display module 21 becomes a cluster image that may be perceived by the driver as displayed on the cluster area 21b of the display module 21. The driver directly may look at the cluster area 21b and perceive the cluster image, and thus the cluster image may not be inverted.

The driver may perceive the HUD image and the cluster image and use the images to drive the vehicle.

The driver may adjust the ratio between the HUD image and the cluster image or the locations thereof, or the control unit 41 may adjust the ratio between the HUD image and the cluster image or the locations thereof, based on the driver's eye position.

To adjust the locations of the images and the ratio therebetween, the driver may correct the vehicle's setup menu, causing the drive motor 31 to rotate to adjust an angle of the display module 21.

In addition, if the control unit 41 is to adjust the locations of the images and the ratio therebetween based on the driver's eye position, the control unit 41 may rotate the drive motor 31.

When the drive motor 31 rotates based on the operation of the driver or the determination of the control unit 41, the support 33 connected to the rotation shaft 32 of the drive motor 31 may rotate, causing the display module 21 to rotate. As the display module 21 rotates, the locations of the images may be adjusted. In addition, as the images are adjusted, the location of the dividing line 21c may also be adjusted, such that the ratio between the HUD image and the cluster image is adjusted.

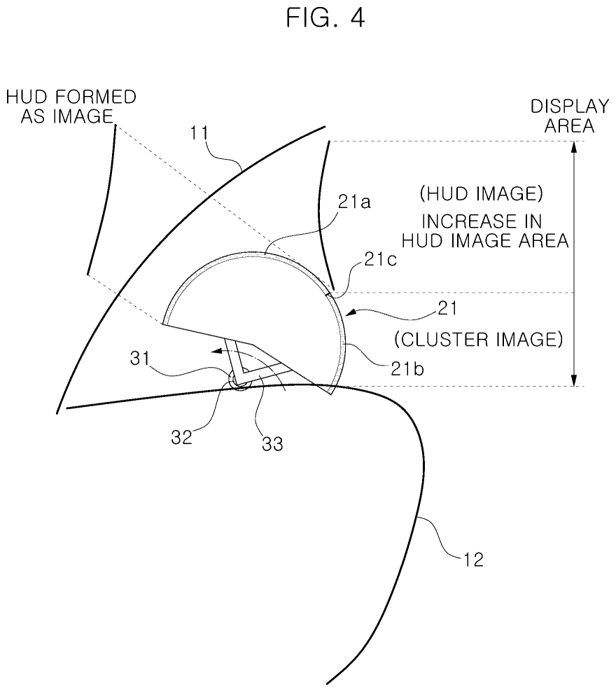

For example, FIG. 4 illustrates an example where the display module 21 rotates counterclockwise (as an arrow indicated in FIG. 4). In this case, the dividing line 21c may rotate clockwise, which is opposite to the rotation direction of the display module 21.

As the display module 21 rotates counterclockwise and the dividing line 21c rotates in the opposite direction thereto, the ratio of the HUD area 21a in the display module 21 may increase, and thus the area of the HUD image in the entire display area of the display module 21 may also increase.

On the other hand, if the display module 21 rotates clockwise and the dividing line 21c moves counterclockwise, the ratio of the HUD area 21a in the display module 21 decreases, and thus the area of the HUD image in the entire display area of the display module 21 may decrease.

While the present disclosure has been described with reference to the accompanying drawings, it will be apparent to those skilled in the art that various changes and modifications can be made without departing from the spirit and scope of the present disclosure without being limited to the exemplary embodiments disclosed herein. Accordingly, it should be noted that such alternations or modifications fall within the claims of the present disclosure, and the scope of the present disclosure should be construed on the basis of the appended claims.

1. A head-up display (HUD) and cluster integrated display assembly comprising a display module positioned on a crash pad of a vehicle, wherein:
a portion of the display module is configured to display HUD information formed as an image on a windshield; and
a remaining portion of the display module is configured to display cluster information.

2. The HUD and cluster integrated display assembly of claim 1, wherein the display module is rotatably positioned on the crash pad, and divided into an HUD area configured to display the HUD information and a cluster area configured to display the cluster information.

3. The HUD and cluster integrated display assembly of claim 2, wherein in the display module, the HUD area is located at an upper portion of the display module, and the cluster area is located below the HUD area.

4. The HUD and cluster integrated display assembly of claim 2, wherein as the display module rotates, a ratio between the HUD area and the cluster area in the display module changes.

5. The HUD and cluster integrated display assembly of claim 1, wherein the display module includes a convexly curved display.

6. The HUD and cluster integrated display assembly of claim 1, further comprising:
a drive motor mounted on the crash pad; and
a support configured to support a bottom surface of the display module and to be rotated by the drive motor.

7. The HUD and cluster integrated display assembly of claim 2, further comprising a control unit configured to transmit information to be displayed to the display module, and to control a drive motor configured to rotate the display module.

8. The HUD and cluster integrated display assembly of claim 7, wherein a dividing line, configured to partition the HUD area and the cluster area, is formed in the display module.

9. The HUD and cluster integrated display assembly of claim 8, wherein the control unit is configured to determine a location of the dividing line in the display module, and the dividing line is located above a lower end of a reflectable area in the windshield and formed as an image on the windshield.

10. The HUD and cluster integrated display assembly of claim 8, wherein the control unit is configured to correct an image displayed on the display module such that the image displayed from the display module appears flat.

11. The HUD and cluster integrated display assembly of claim 8, wherein when the display module rotates, the control unit is configured to move the dividing line in a direction opposite to a rotation direction of the display module.

12. The HUD and cluster integrated display assembly of claim 7, further comprising an image generation unit configured to generate images to be displayed on the HUD area and the cluster area in the display module, and to provide the generated images to the control unit.

13. The HUD and cluster integrated display assembly of claim 7, wherein the control unit is configured to detect a driver's eye position by using an interior camera mounted within the vehicle, and to correct images to be displayed on the HUD area and the cluster area.

14. A head-up display (HUD) and cluster integrated display assembly for a vehicle, comprising:
a crash pad of a vehicle;
a display module rotatably positioned on the crash pad of the vehicle; and
a control unit configured to transmit information to be displayed to the display module, and to control a rotation the display module;
wherein a portion of the display module is configured to display HUD information formed as an image on a windshield; and
wherein a remaining portion of the display module is configured to display cluster information.

15. The HUD and cluster integrated display assembly of claim 14, wherein the display module includes an HUD area configured to display the HUD information, a cluster area configured to display the cluster information, and a dividing line configured to partition the HUD area and the cluster area.

16. The HUD and cluster integrated display assembly of claim 15, further comprising an image generation unit configured to generate images to be displayed on the HUD area and the cluster area in the display module.

17. The HUD and cluster integrated display assembly of claim 15, further comprising a camera positioned in an interior of the vehicle and configured to detect an eye position of a driver of the vehicle, and wherein the control unit is configured to detect a driver's eye position by using the camera and correct images to be displayed on the HUD area and the cluster area.

18. The HUD and cluster integrated display assembly of claim 15, wherein the control unit is configured to correct an image displayed on the display module so the image displayed from the display module appears flat, and to determine a location of the dividing line in the display module.

19. The HUD and cluster integrated display assembly of claim 18, wherein the control unit is configured to rotate the display module to move the dividing line.

20. The HUD and cluster integrated display assembly of claim 14, wherein the display module includes a display convexly curved in an upward direction from the crash pad of the vehicle.
